(19) United States
(12) Patent Application Publication
(10) Pub. No.: US 2006/0031050 A1
(43) Pub. Date: Feb. 9, 2006

(54) Radiation dose uncertainty code

(76) Inventors: Wesley Emmett Bolch, Gainesville, FL (US); Eduardo Balderrama Farfan, Orangeburg, SC (US); Thomas Edward Huston, Johnson City, TN (US); William Emmett Bolch JR., Gainesville, FL (US)

Correspondence Address: AKERMAN SENTERFITT, P.O. BOX 3188, WEST PALM BEACH, FL, 33402-3188, US

(21) Appl. No.: 10/677,897

(22) Filed: Sep. 30, 2003

Related U.S. Application Data
(60) Provisional application No. 60/415,359, filed on Oct. 1, 2002.

(51) Int. Cl. G06G 7/48

(52) U.S. Cl. 703/11

(57) ABSTRACT

Systems, machine readable storage, and methods for solving a respiratory tract model of radiation dosage. Steps include selecting input parameters associated with a respiratory tract model, computing a probability density function for the input parameters, and solving the respiratory tract model using the computed probability density functions.

### CROSS REFERENCE TO RELATED APPLICATIONS

This application claims priority from U.S. Provisional Application Ser. No. 60/415,359 filed Oct. 1, 2002. The foregoing is incorporated herein by reference in its entirety.

### STATEMENT AS TO FEDERALLY FUNDED RESEARCH

This invention was made with U.S. government support under grant numbers R32/CCR409769 and R32/CCR416743 awarded by the Centers for Disease Control and Prevention and under a grant awarded by the Department of Energy (Nuclear Engineering and Health Physics Fellowship Program). The U.S. government may have certain rights in the invention.

### FIELD OF THE INVENTION

This invention relates generally to the fields of nuclear physics, radiation and medicine. More particularly, the invention relates to methods of determining dosages of radiation.

### BACKGROUND

Radioactive materials are used in a wide range of industrial manufacturing processes, and in research and medical procedures. They can be also be used in terrorist devices, for example, as components of “dirty bombs.” It is well known that exposure to radioactive materials can create serious health problems in human and animal populations. Many subjects are at risk for exposure to radiation, including workers in manufacturing facilities using radioactive materials, victims of radiation accidents at nuclear facilities, personnel in military settings (such as in nuclear submarines), and victims of radioactive weapons.

The risks of radiation exposure mandate the need for elaborate systems for regulation of use of radioactive materials, compliance by users of these materials, and compensation systems for victims of excessive exposure to radioactive materials. In order to be effective for protection of human populations, such systems must be able to both predict safe internal doses of radiation exposure for any radionuclide of interest, and permit the reconstruction of past radiation doses, for example to worker populations exposed to radiation over a period of time, or to potential or actual victims of a radioactive accident or weapon.

Certain employers of workers exposed to radiation must further operate under recent government mandates, such as The Energy Employees Occupational Illness Compensation Program (EEOICPA), to provide compensation to workers who develop a disease, such as cancer, and submit a claim under that program alleging that the disease was caused by the work-related radiation exposure. Proof of causation required for a claimant-favorable decision involves a probability of causation determination (50% or greater at the 99% credibility limit of probability). Accurate prediction of the radiation dose experienced by a particular claimant is an integral part of the calculation used to retroactively determine the likelihood of causation.

Exposure to radiation by inhalation is the most likely exposure route to affect a large population. Accordingly, the ability to predict internal doses of radiation sustained by the inhalation route has been recognized as highly important for the predictive system required for regulation of use of radioactive materials. A model has been developed by the International Commission on Radiological Protection (ICRP), for estimation of internal doses of radiation delivered to tissues of the human respiratory tract following exposure by inhalation. The most recent revision of the model is known as ICRP-66, and is described in ICRP Publication 66 (1994).

Assessment of equivalent doses to the respiratory tract following the inhalation of radioactivity requires detailed understanding of particle deposition, particle clearance, and localized radiation dosimetry of the respiratory tract tissues. Radiological risk assessment capability in the latest revision of the ICRP-66 model provides for variations in particle deposition, clearance, and dosimetry with changes in subject age, sex, level of physical exertion, and method of inhalation (nasal, or oral, or combinations of both). Some 69 parameters are specified within the ICRP-66 respiratory tract model: 26 related to particle deposition, 23 related to particle clearance, and 20 related to radiation dosimetry. For each parameter, reference values are given in ICRP Publication 66, providing for deterministic solutions to regional doses to lung tissues.

Regulatory compliance programs require computer models capable of providing the most accurate information available with respect to radiation doses received in a given inhalation exposure event. Existing computer programs designed to implement the ICRP-66 respiratory tract model make use of default input parameters, based on generic standards such as Reference Man. For a given set of inhalation exposure parameters, these codes provide only deterministic, point estimates (mean and median) of organ and effective doses. Improved accuracy is needed in attempts to correlate biological effects with radiation doses.

### SUMMARY

The invention provides in one aspect a computer code that solves the deposition, clearance and dosimetry components of the ICRP-66 respiratory tract model by providing not only mean and median estimates of effective doses for a given set of inhalation exposure parameters, but also information on the total uncertainty for those same doses. The code permits the user to estimate the probability distribution of potential organ and effective doses that a subject might receive from an inhalation exposure event involving a given radionuclide.

The code design acknowledges that parameters of the ICRP-66 model are either not known with great certainty, or are subject to biological variability among individuals of an exposed population. In one aspect, the code of the invention permits input of parameters unique to an individual subject's exposure scenario, such as the subject's sex, age, exertion level, body height and body mass index, in addition to input regarding the radionuclide, the particle size distribution, and solubility of the particles in the lung fluids.

The code provides for determination of probability distributions by using stochastic sampling of input parameter values. In preferred embodiments of the code, probability distributions are obtained by sampling of input parameter values using Latin Hypercube techniques. For each of the current 69 input parameters of the ICRP-66 human respiratory tract model, probability density functions can be assigned, rather than single-valued default numbers. Both organ equivalent doses and whole-body effective doses can be determined for some 233 potentially inhaled radionuclides. Radionuclide types analyzable by the code of the invention include those emitting different classes of radioactive particles, such as alpha particles, beta particles, X-ray photons, and gamma ray photons.

Accordingly, in one aspect the invention provides a method for solving a respiratory tract model including the steps of: selecting a group of input parameters associated with a respiratory tract model, computing a probability density function for each of the input parameters in the group, and solving the respiratory tract model associated with the input parameters using the computed probability density functions.

The selecting step can include the steps of selecting a group of input parameters associated with a respiratory tract model, including an ICRP-66 Respiratory Tract Model. The parameters can include at least one parameter associated with the ICRP-66 Respiratory Tract Model.

The solving step of the method can include the step of generating at least one of a mean estimate, a median estimate and an uncertainty of a radiation dose based upon the computed probability density functions.

The method can further include the step of modifying the respiratory tract model to explicitly represent anatomical structures of a human being. The anatomical structures can include at least one of an external nose, nasal cavity, nasal sinus, larynx, pharynx, trachea, main bronchus and esophagus.

In another aspect, the invention provides a machine readable storage having stored thereon a computer program for solving a respiratory tract model. The computer program can include a routine set of instructions for causing the machine to perform the steps of: selecting a group of input parameters associated with a respiratory tract model, computing a probability density function for each of the input parameters in the group, and solving the respiratory tract model associated with the input parameters using the computed probability density functions.

The invention further provides a system for solving a respiratory tract model including: a scenario specification module for defining an exposure scenario, a Latin Hypercube sampling module, a particle deposition module for repeatedly computing a particle deposition component of a respiratory tract model, a clearance component module for repeatedly computing a clearance component of the respiratory tract model, a dose matrix computing component for computing a dose matrix for alpha particles, a Monte Carlo N-Particle (MCNP) module both for determining absorbed beta particle fractions and specific absorbed photon fractions, a dose computation module for computing equivalent doses and combined doses in target tissues, and an interface through which statistical representations are provided from the deposition, clearance and dose computation modules. The statistical representations of the system can include at least one of a minimum, maximum, median, mean, standard deviation, coefficient of variance, geometric mean, geometric standard deviation and percentile. The respiratory tract model of the system can be an ICRP-66 Respiratory Tract Model.

### BRIEF DESCRIPTION OF THE DRAWINGS

The invention is pointed out with particularity in the appended claims. The above and further advantages of this invention may be better understood by referring to the following description taken in conjunction with the accompanying drawings, in which:

FIG. 1 is a flowchart showing the organization of the LUDUC computer program modules.

FIG. 2 shows a Main Menu window of LUDUC.

FIG. 3 shows an Open Project Files window of LUDUC.

FIG. 4 shows an Edit/View Input Parameter Distributions window of LUDUC.

FIG. 5 shows a Population Class Selection window of LUDUC.

FIG. 6 shows an Aerosol Characteristics window of LUDUC.

FIG. 7 shows an Exposure Conditions window of LUDUC.

FIG. 8 shows a Periodic Table of the Elements window of LUDUC.

FIG. 9 shows a Periodic Table of the Elements window of LUDUC.

FIG. 10 shows a Run Parameter Setup window of LUDUC.

FIG. 11A shows a Deposition Model Input Parameters window of LUDUC.

FIG. 11B shows a Distribution Selection window of LUDUC.

FIG. 12 shows a Clearance Model Input Parameters window of LUDUC.

FIG. 13 shows a Dose Model Input Parameters window of LUDUC.

FIG. 14 shows LUDUC running from a Main Menu window.

FIG. 15 shows a Results of Run Under Specified Conditions window of LUDUC.

FIG. 16 shows a Variability and Uncertainty in Regional Deposition in Human Respiratory Tract window of LUDUC.

FIG. 17 shows an Expanded View of Selected Histogram window of LUDUC.

FIG. 18 shows an Extrathoracic Region: Uncertainty and Variability in Clearance Model Predictions window of LUDUC.

FIG. 19 shows an Expanded View of Selected Histogram (Activity Remaining in ET1) window of LUDUC.

FIG. 20 shows an Uncertainty in Regional and Combined Dose for Human Respiratory Tract (Alpha-Particles) window of LUDUC.

FIG. 21 shows a Median Equivalent Dose Values (Alpha-Particles) window of LUDUC.

FIG. 22 shows an Equivalent Dose Weighted Median Values (Alpha-Particles) window of LUDUC.

FIG. 23 shows an Uncertainty in Regional and Combined Dose for Human Respiratory Tract (Beta-Particles) window of LUDUC.

FIG. 24 shows an Uncertainty in Regional Dose for Organ Group A (Gamma-Rays and X-Rays) window of LUDUC.

FIG. 25 shows an Uncertainty in Regional Dose for Organ Group B (Gamma-Rays and X-Rays) window of LUDUC.

FIG. 26 shows an Uncertainty in Regional Dose for Organ Group C (Gamma-Rays and window of LUDUC.

FIG. 27 shows an Uncertainty in Regional and Combined Dose for Human Respiratory issue Equivalent Dose, Sv) window of LUDUC.

FIG. 28 shows an Uncertainty in Effective Dose (Sv) window of LUDUC.

### DETAILED DESCRIPTION

### Description of the Lung Dose Uncertainty Code (LUDUC)

Prior to the invention, existing codes that implement the ICRP-66 Respiratory Tract Model provide deterministic, point estimates of organ or effective dose for a given set of inhalation exposure parameters. The invention provides a computer code, termed LUDUC, which allows a user to solve the deposition, clearance, and dosimetry components of the ICRP-66 Respiratory Tract Model using stochastic, as opposed to deterministic, sampling of input parameter values for example by using Latin Hypercube techniques. For each of the 69 input parameters of the model, probability density functions can be assigned, rather than single default values. The code provides not only mean and median estimates of doses under any selected set of exposure conditions, but also information on the total uncertainty (for example, at the 95% confidence level) for those doses. Such information on dose uncertainty is extremely useful, both for demonstrating compliance with a regulatory dose limit, and for dose reconstruction analyses, which involve correlating past worker doses with observed biological effects, such as diseases. Both organ equivalent doses and whole-body effective doses can be determined for at least 233 potentially inhaled radionuclides, including those emitting alpha-particles, beta-particles, and X- or gamma-ray photons.

The LUDUC code permits the user to select various aspects of the exposure scenario, such as radionuclide, particle size distribution and solubility of the particles in the lungs. The code further provides for predictions that take into account biological variability among individuals of an exposed population, including an individual's sex, age, exertion level, body height, and body mass index. As shown in the examples described herein, variability in one or more of these parameters can significantly affect the confidence levels of the predicted level of radiation exposure.

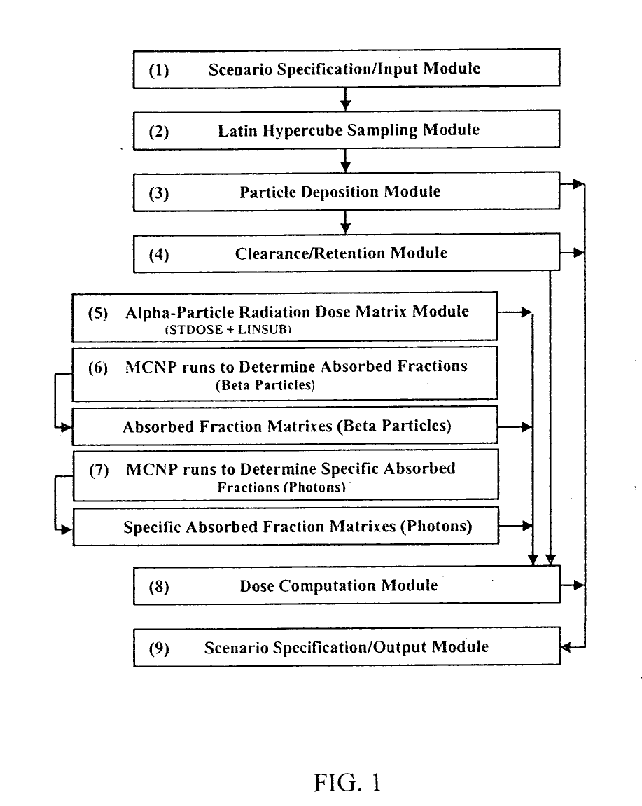

Referring now to FIG. 1, LUDUC can be structured into nine modules as indicated in the flowchart. The Scenario Specification/Input module is written in Visual Basic v6.0 and can run in the Microsoft Windows 2000/XP environment. This programming language makes full use of the graphical user interface and multitasking capabilities offered by the MS Windows environment. The assessment problem requires an exposure scenario to be defined by specifying: (1) an age and gender of an exposed population group, (2) a physical exertion level of the group during the exposure (assumed to be acute for computational purposes), (3) an activity-particle size distribution, a particle shape factor, and a particle density, and (4) an ambient temperature and pressure. The user can optionally specify an ambient activity concentration level, and an exposure duration. Otherwise, quantities are assessed per unit exposure. The code can allow for monodisperse particles, a lognormal particle size distribution, a uniform distribution, or a user-supplied histogram (normalized) of particle sizes.

The source code of Modules 1 and 9 is written in Visual Basic. The source code of Modules 2 through 8 is written in FORTRAN and thus is portable to other operating systems. Modules 2 through 8 have been compiled/linked using Lahey FORTRAN 90 v4.50.

The second module embodies Latin Hypercube Sampling (LHS) algorithms developed by Iman and Shortencarier (1984) at Sandia National Laboratories, with minor modifications to the source code. The LHS module reads an input file created by the first module, creating a matrix of N input parameter arrays to be utilized by LUDUC in the N trials to be run in the uncertainty analysis.

The third module solves the particle deposition component of the ICRP 66 respiratory tract model N times, to generate N predictions of particle deposition fractions in the various regions of the lung.

The fourth module solves the clearance component of the respiratory tract model and implements an algorithm described by Birchall (1986) to solve the resulting system of differential equations. The purpose of this module is to solve the clearance model N times to generate N predictions of either the number of nuclear transformations or the transformation rate in source components after a specified time.

The fifth module can be a stand-alone program that computes a dose matrix for alpha particles used as input to the dose computation module.

The sixth and seventh modules are a set of programs in Visual Basic and FORTRAN used to run Monte Carlo N-Particle (MCNP) quickly and efficiently for monoenergetic beta particles and photons, respectively. This set of programs was also utilized to create absorbed fraction (beta particles) and specific absorbed fraction (photons) data for 233 radionuclides. These data tables are used by LUDUC when it runs.

The eighth module computes equivalent doses in target tissues and the combined lung dose (for example, the weighted sum of the regional doses). This module couples results from clearance model computations with target and source geometries. Using data generated by the LHS module for parameters such as target and source dimensions and masses (based on assigned input distributions), this module solves the dose model N times, for N values of the various dose quantities. Module 8 also estimates the effective dose and considers alpha-particle, beta-particle, and photon emitters.

The ninth module gives the numerical results from the deposition, clearance, and dosimetry modules in terms of histograms with their corresponding statistical parameters. These parameters can include the minimum, maximum, median, mean, standard deviation, coefficient of variance, geometric mean, geometric standard deviation, and several percentiles for predicted quantities. These quantities can include (1) deposition fractions in the ET₁, ET₂, BB, bb, AI, total thoracic, and total respiratory tract, (2) total radionuclide transformations at time t since exposure for all source components in the respiratory tract, and (3) equivalent doses to these target tissues.

The results of the dose computation module are presented by the ninth module for individual radiation types and their overall contribution to equivalent dose. For short-range particles such as alpha and beta particles, Module 9 shows results for the extrathoracic and thoracic target tissues. For photons, this module displays results for 34 target organs and tissues. The results for the lung include the contributions of the alpha particles, beta particles, and photons emitted by the radionuclide selected by the LUDUC user. This module is written in Visual Basic and runs in the MS Windows environment. Finally, this module presents the effective dose in Sieverts. If needed, the user can easily obtain the data generated by LUDUC for storage or further processing in spreadsheet programs.

Modules 1 through 9 can all be run from a single computational platform in MS Windows. Modules 2, 3, 4, 5, 6, 7 and 8 are run by a shelling command, which temporarily transfers control from Windows to MS-DOS. For a sample size of N=1, this platform was shown to run in less than a second on a 2.0-GHz personal computer system.

### User Operation of LUDUC

To start LUDUC, the user clicks on a LUDUC icon (not shown). When LUDUC is executed, it displays the version number and authors, and a LUDUC banner. The user can click on the banner to start LUDUC, or the program will start automatically in several seconds after the LUDUC banner is displayed.

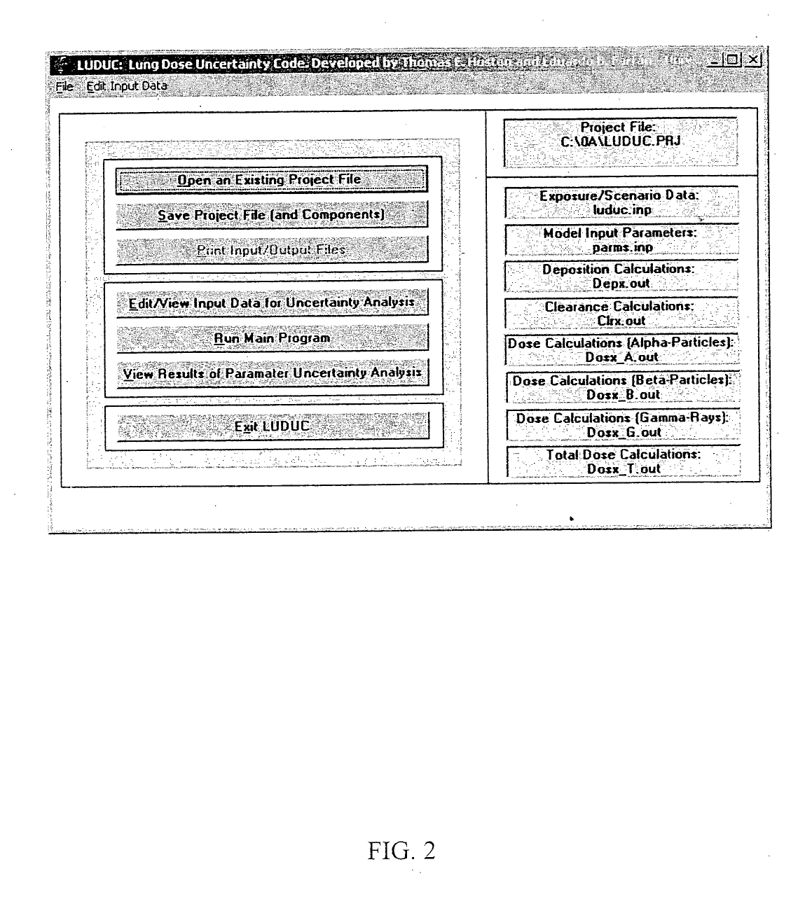

The Main Menu appears once the banner disappears (FIG. 2). The Main Menu shows the main commands in LUDUC such as Open an Existing Project File, Save Project File, Print Input/Output Files, Edit/View Input Data for Uncertainty Analysis, Run Main Program, View Results of Parameter Uncertainty Analysis and Exit LUDUC. The Main Menu also displays the following filenames: Project File, Exposure/Scenario Data, Model Input Parameters, Deposition Calculations, Clearance Calculations, Dose Calculations (for alpha- and beta-particles, and gamma-rays) and Total Dose Calculations. These files store the necessary information to run LUDUC. The user can modify these filenames by clicking on the specific filename and editing it. The Main Menu also shows the time and date.

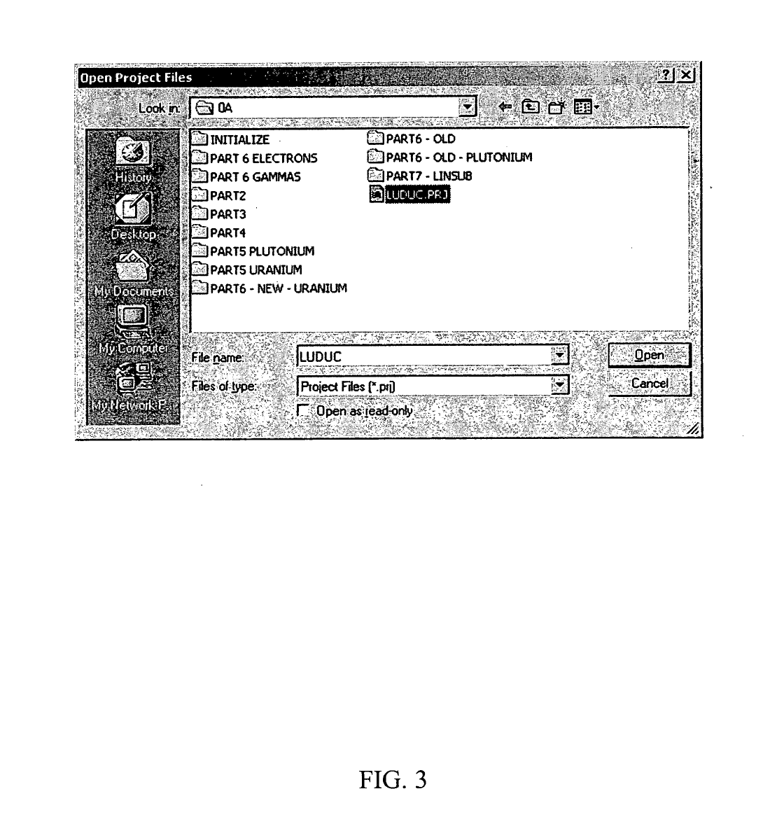

Selection of the Main Menu command Open an Existing Project File (shown in FIG. 2) allows the user select an initial project file to run LUDUC (FIG. 3). The project file (for example, LUDUC.PRJ) is the filename of the file containing the necessary data for the input parameters and output (i.e., results).

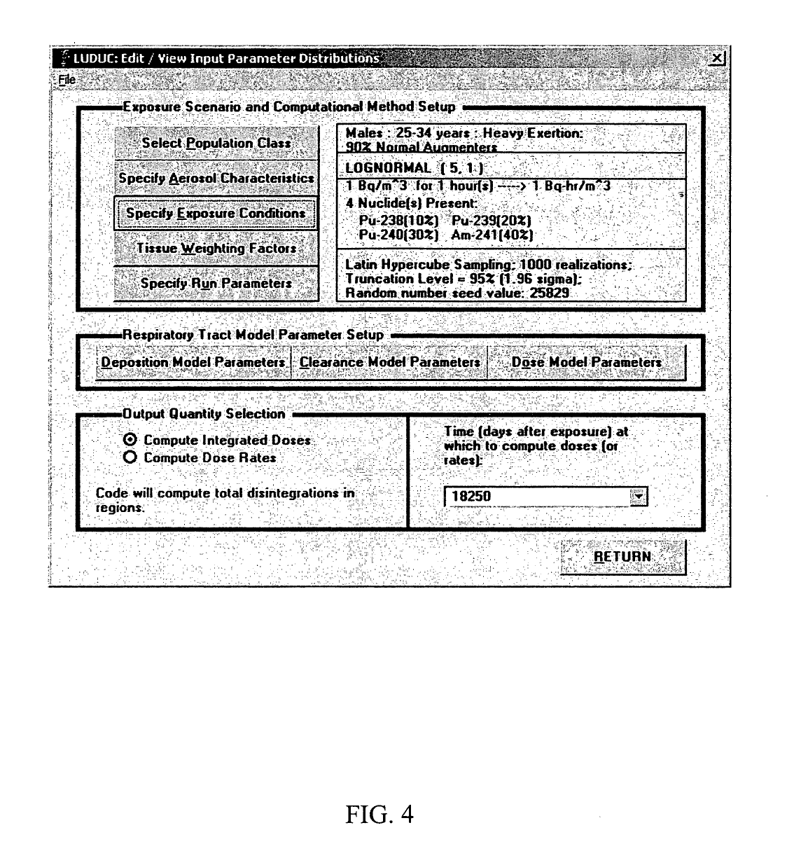

To modify and/or verify the input parameters, the user clicks on the Main Menu command Edit/View Input Data for Uncertainty Analysis, causing display of a window, Edit/View Input Parameter Distributions, shown in FIG. 4. This window is subdivided into several parts, including an Exposure Scenario and Computational Method Setup window, a Respiratory Tract Model Parameter Setup window, and an Output Quantity Selection window.

The Exposure Scenario and Computational Method Setup window includes on the right a summary of the exposure scenario and computational setup. Five commands, displayed on the left, allow the user to modify the corresponding data.

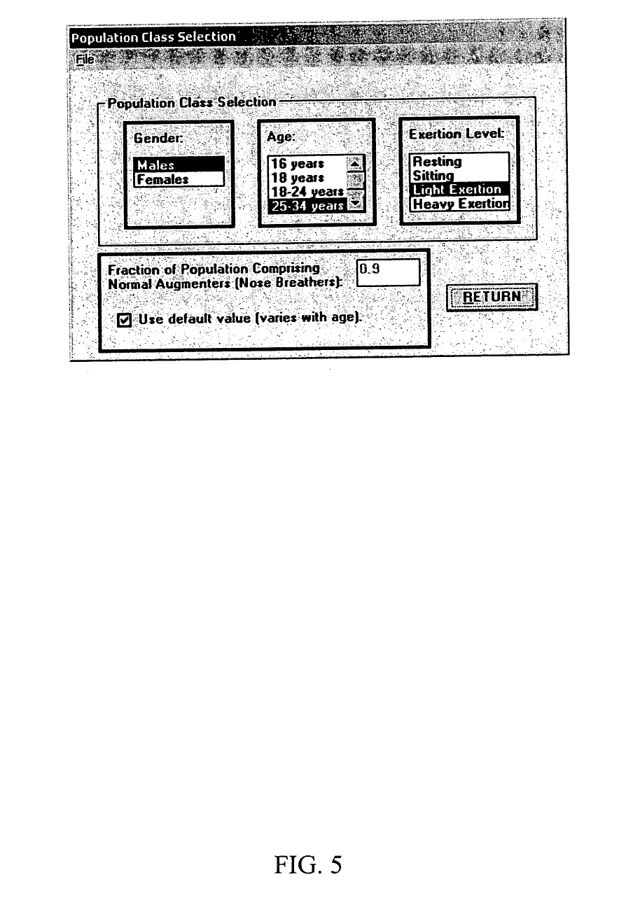

Referring to the upper left of FIG. 4, by selecting the command Select Population Class, the user is able to view or edit the gender, age, exertion level, and fraction of nose breathers for a specific population group, as shown in FIG. 5.

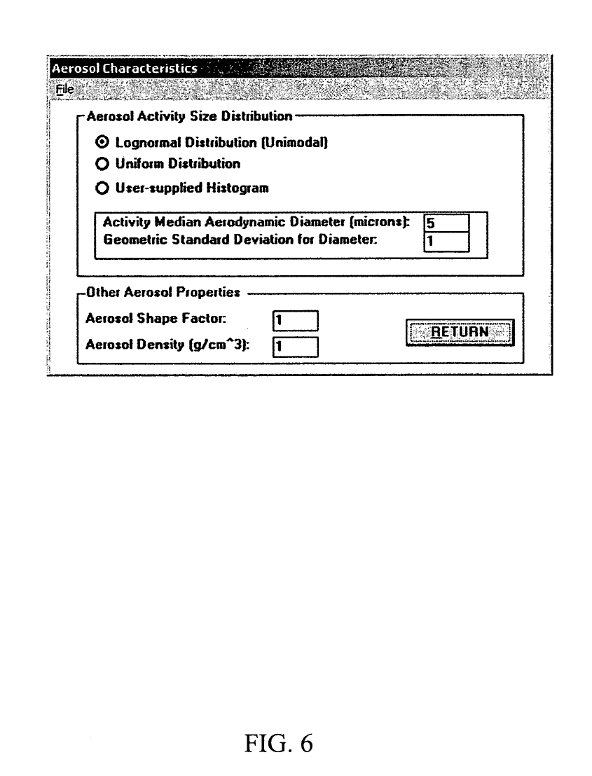

By selecting the Specify Aerosol Characteristics command (FIG. 4), the user is able to view or edit the aerosol activity size distribution, in a window illustrated in FIG. 6. Distribution choices include lognormal, uniform, and user-supplied histogram. Aerosol characteristics that the user can view or edit include an Activity Median Aerodynamic Diameter (in microns), a Geometric Standard Deviation for Diameter, an Aerosol Shape Factor, and an Aerosol Density (in g/cm³).

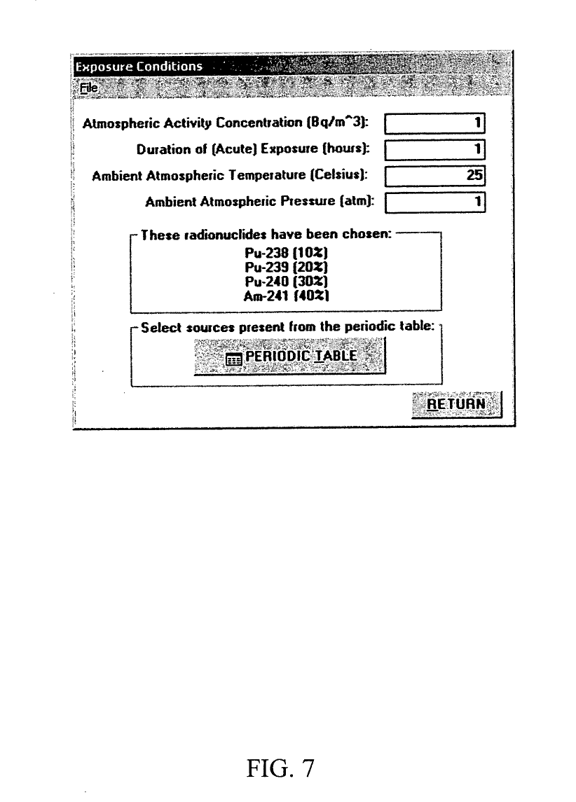

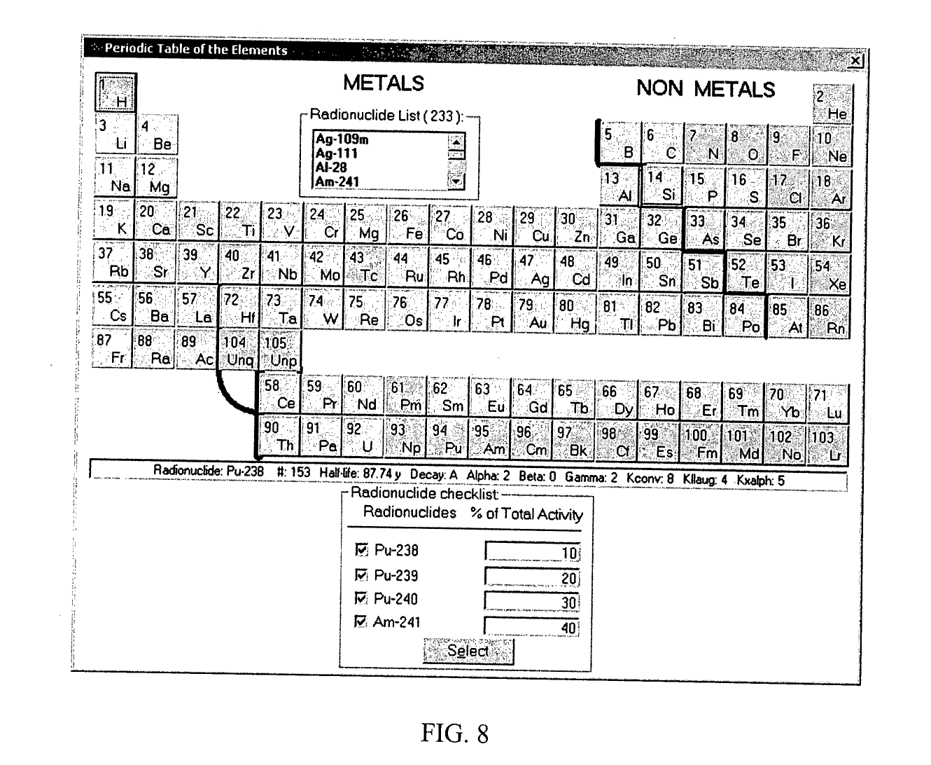

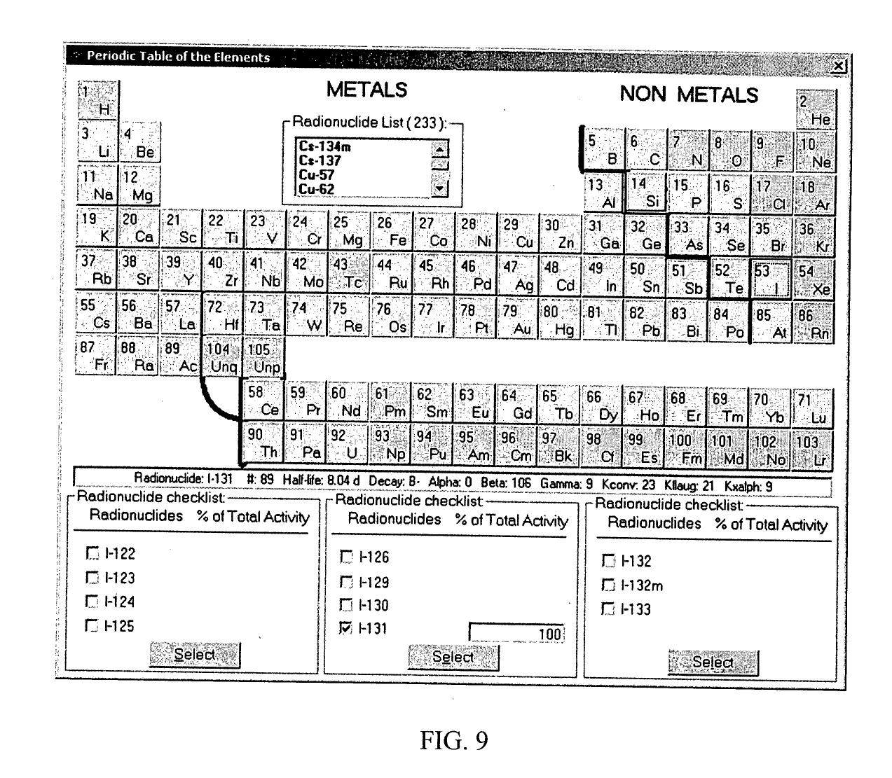

Referring again to the upper left of FIG. 4, by activating the command Specify Exposure Conditions, the user can view or edit the atmospheric activity concentration, duration of exposure, ambient atmospheric temperature and pressure, and the radionuclide(s) for the specific scenario, as shown in FIG. 7. To select the radionuclide(s), the user clicks on Periodic Table, to display a window illustrating the periodic table of the elements (FIG. 8). This window allows the user to select the radionuclide(s) in two different ways: (1) by clicking on a desired element in the display of elements or (2) by selecting a radionuclide from the dropdown Radionuclide List. Below the periodic table, important information about the selected radionuclide is shown, such as half-life, and number of alpha and beta particles emitted. As examples of the type of information displayed, FIG. 8 shows the selection of the main components of Weapons Grade plutonium and FIG. 9 shows the selection of iodine-131. Having selected the radionuclide, the user can input the percent of total activity in the Radionuclide Checklist (FIGS. 8 and 9).

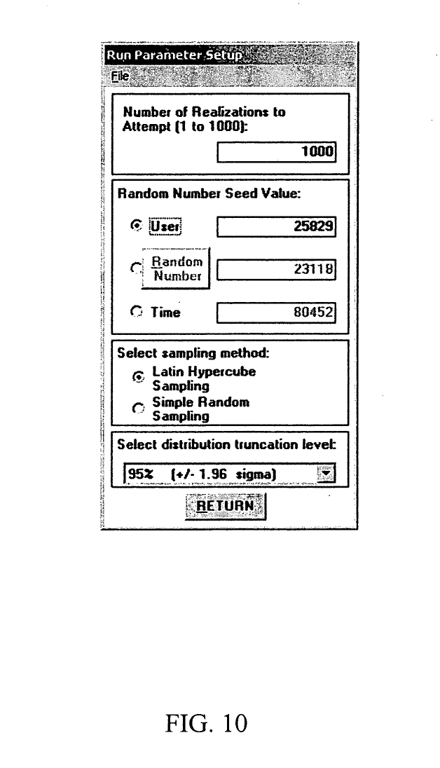

By selecting the command Specify Run Parameters (FIG. 4), the user can view or edit the parameter setup, which includes the sampling method (i.e., simple random sampling or Latin Hypercube sampling), the number of trials or realizations, the distribution truncation level, and the random number seed value. A Run Setup Parameter window is shown in FIG. 10. The random number seed can be selected by a direct input from the user, by a random number generated by the Visual Basic, or by computer time.

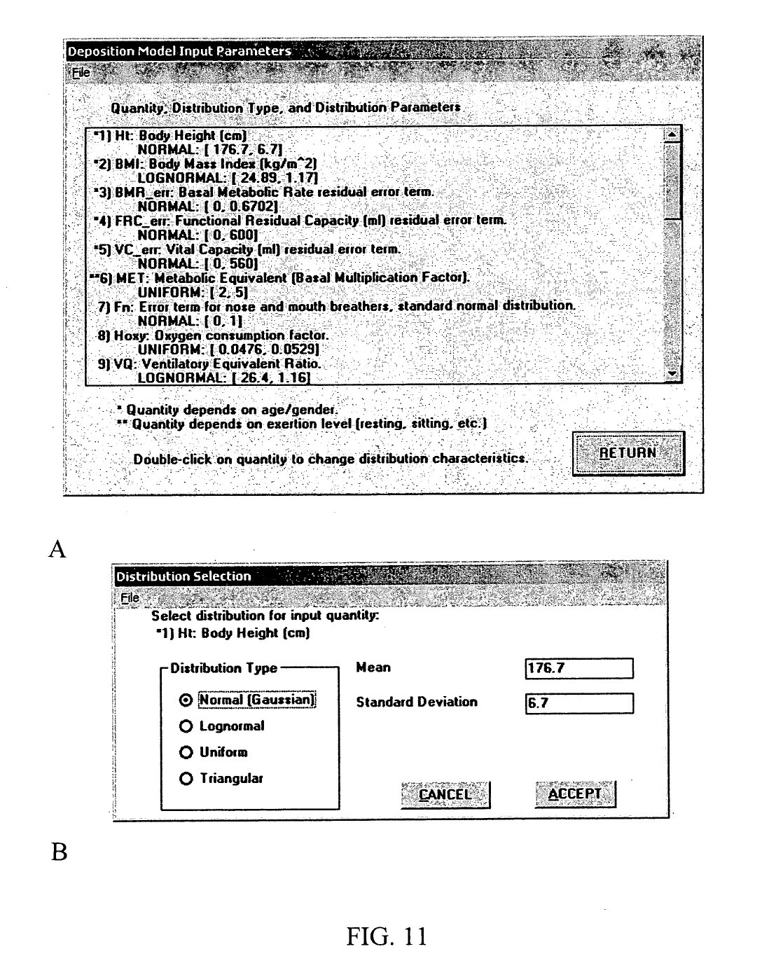

Referring now to the middle of the window shown in FIG. 4, the Respiratory Tract Model Parameter Setup window allows the user to modify and/or verify the parameters for the deposition, clearance, and dose models. By clicking on the command Deposition Model Parameters, the user can view or edit the quantity, distribution type, and distribution parameters of the deposition model, as shown in FIG. 11A. By double-clicking on a quantity, such as Body Height, the user can modify the distribution characteristics, for example as shown in FIG. 11B. Four different distribution types are available, including Normal (Gaussian), Lognormal, Uniform, and Triangular. The user selects the distribution and necessary parameters (mean and standard deviation for a normal distribution), then accepts the choice by clicking on the Accept command.

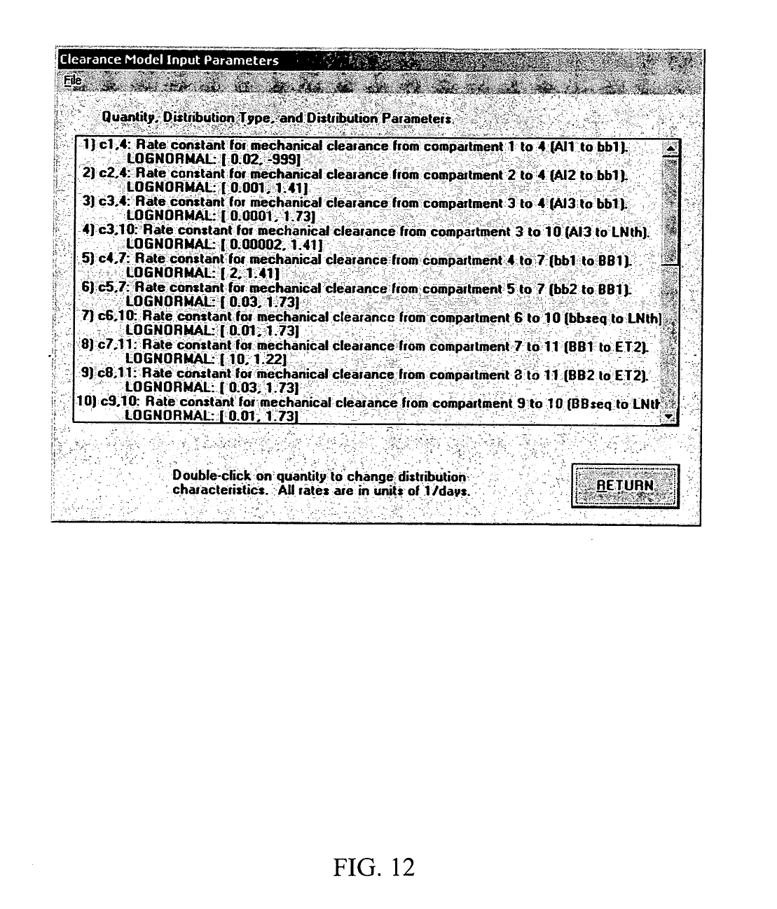

Selecting the command Clearance Model Parameters in the Respiratory Tract Model Parameter Setup (middle of FIG. 4), the user can view or edit the quantity, distribution type, and distribution parameters of the clearance model. (See FIG. 12.) The procedure to modify the distribution parameters of the clearance model is similar to that for modifying the parameters of the deposition model.

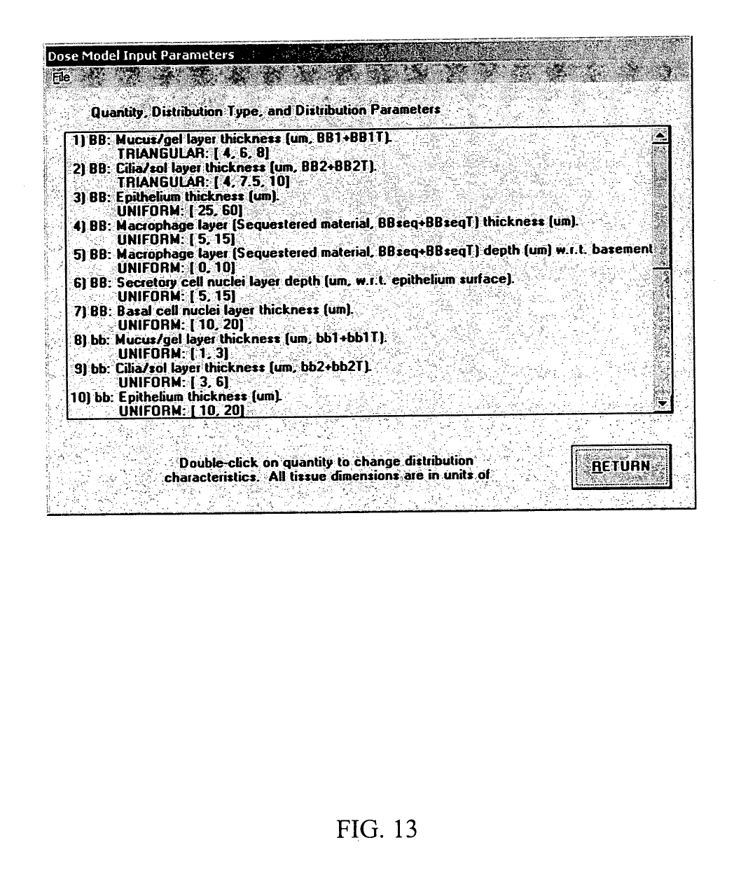

By selecting the Dose Model Parameters command in the Respiratory Tract Model Parameter Setup (FIG. 4), the user can view or edit the quantity, distribution type, and distribution parameters of the dose model, as shown in FIG. 13. The procedure to modify the distribution parameters of the dose model is similar to that for the deposition and clearance models.

Referring to the lower portion of FIG. 4, the Output Quantity Selection window allows the user to compute integrated doses or dose rates based on elapsed time (for example, days) after exposure to radiation.

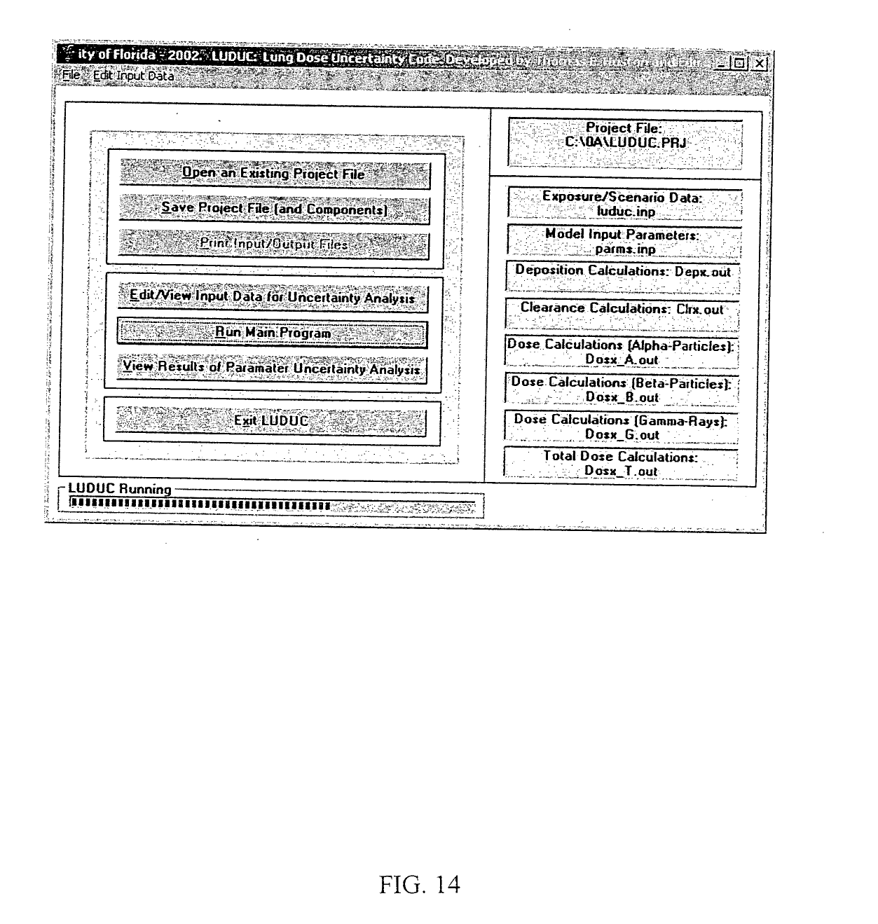

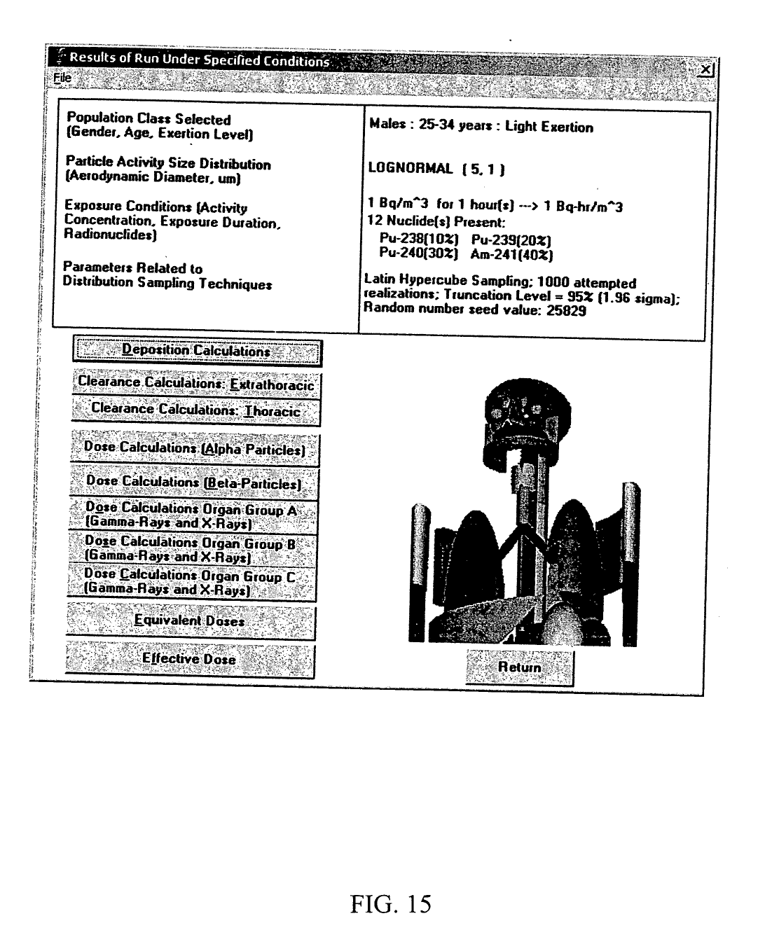

Referring now to FIG. 14, to execute LUDUC, the user selects Run Main Program. LUDUC indicates to the user when it is finished running. By selecting the command View Results of parameter Uncertainty Analysis, the user can see the results of the run under the specified conditions. A typical window showing such results is illustrated in FIG. 15. A summary of input parameters (population class, particle size distribution, exposure conditions, and distribution sampling techniques) appears in the upper portion of the window. To observe the results for the Deposition, Clearance, and Dose Models, the user clicks on the corresponding commands, shown in the lower left of FIG. 15. To return to the previous window, the user can click on a Return command.

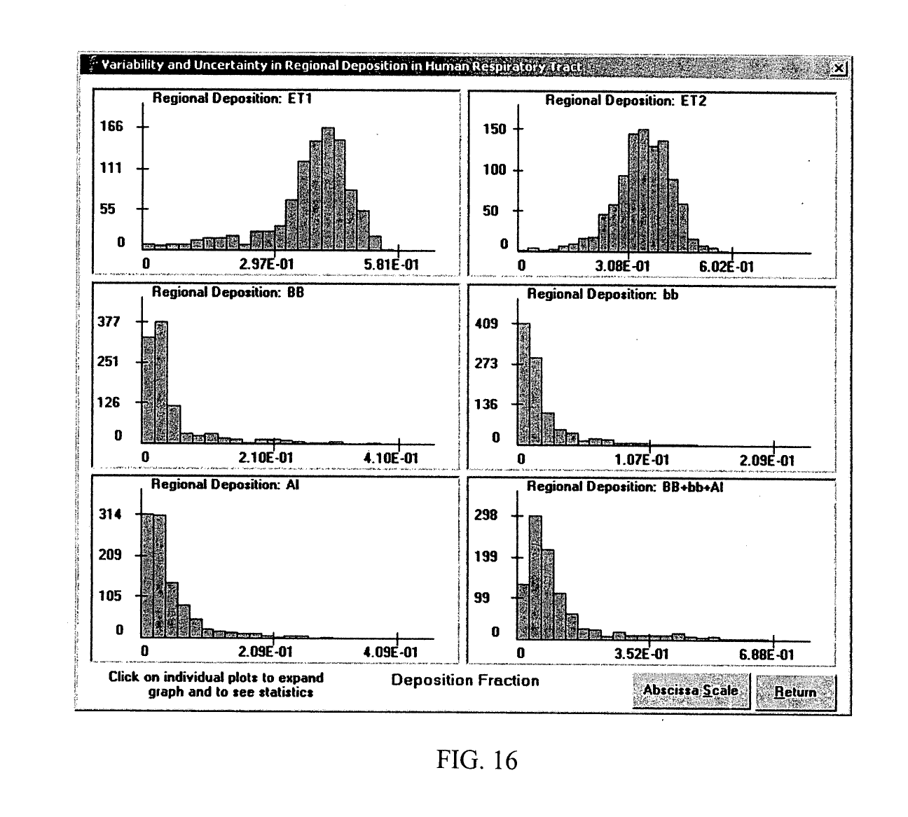

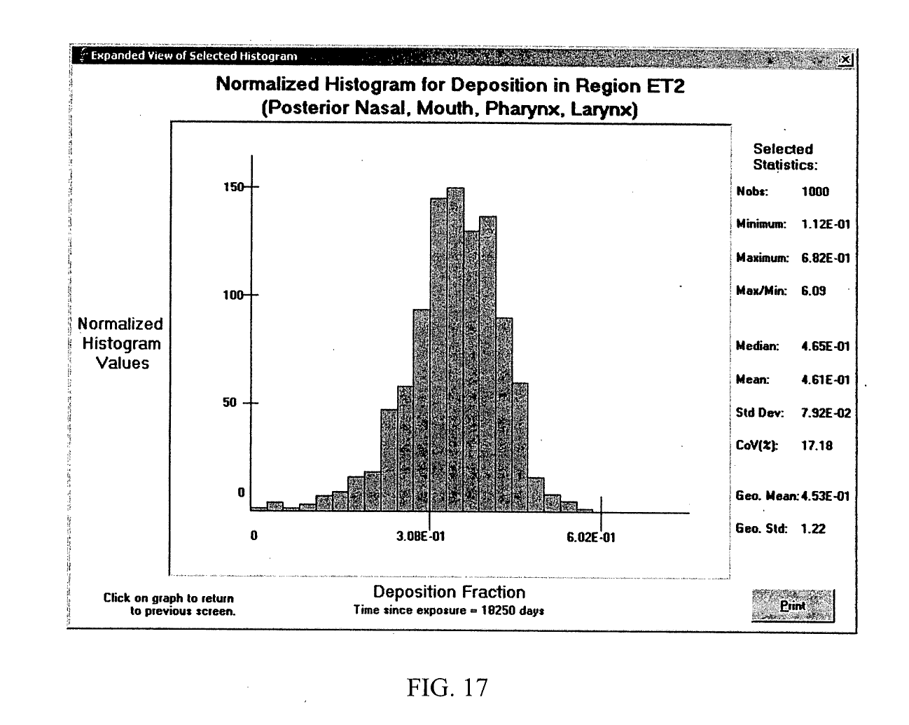

When selecting the command Deposition Calculations (FIG. 15), the user is able to observe the Deposition Model results (deposition fractions in various regions of the respiratory tract) as shown in FIG. 16. The user is able to modify the horizontal scale of the plots by clicking on the command Abscissa Scale. This modification of the horizontal scale applies to all the plots in LUDUC. To view probabilistic results, the user can click on the individual plots, to expand the graph and to see statistical data, such as that shown in FIG. 17. The feature of clicking on a plot to view the statistics applies to all plots displayed in the LUDUC program. Displayed statistics include the number of observations (trials), minimum, maximum, maximum-to-minimum ratio, median, mean, standard deviation, coefficient of variability, geometric mean, and geometric standard deviation. To return to the previous window (FIG. 16), the user clicks on the plot itself.

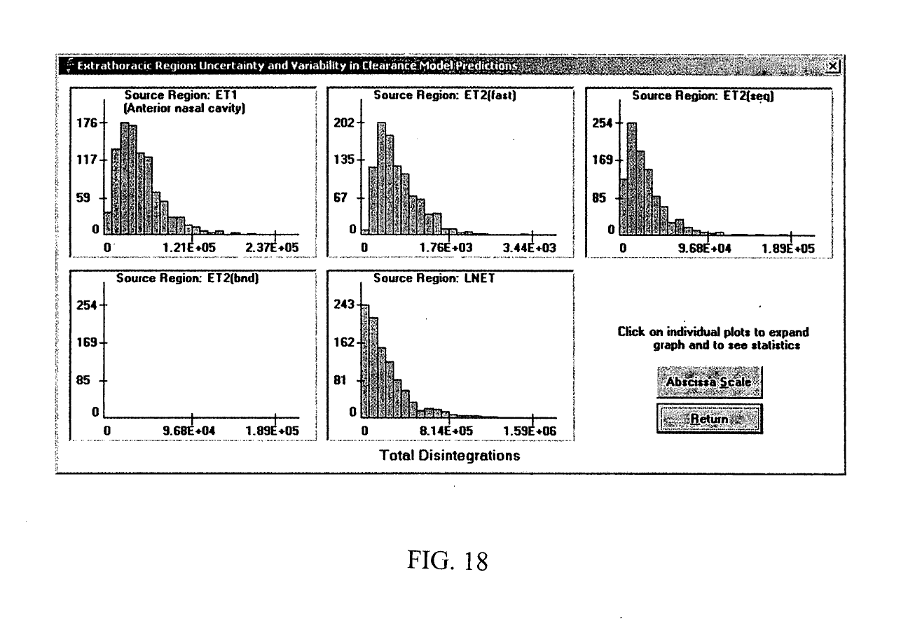

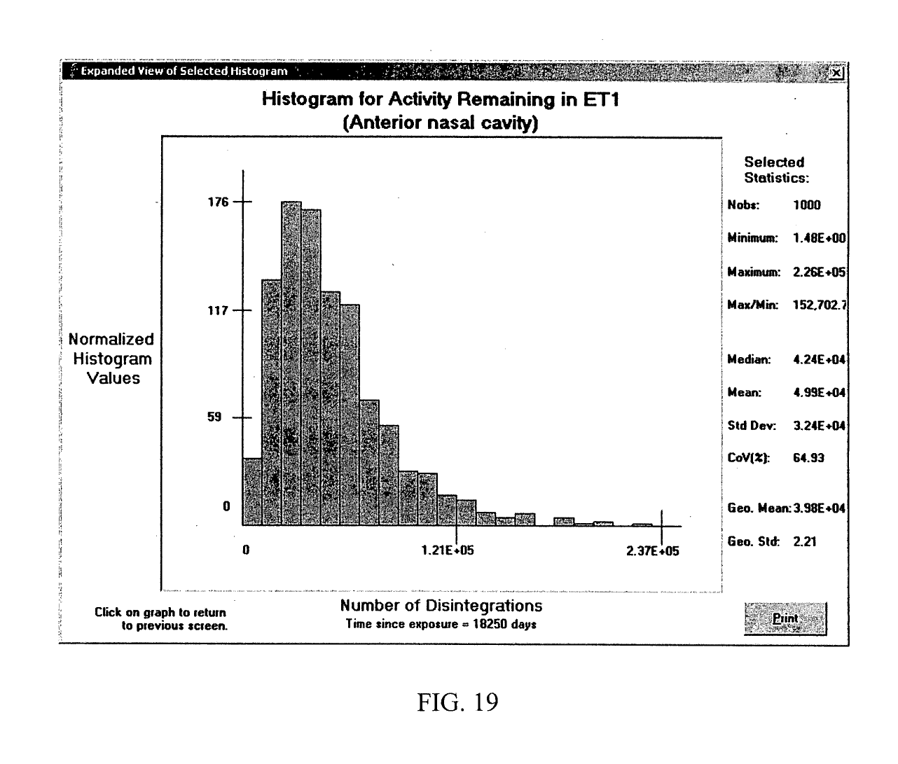

Referring again to FIG. 15, the user can select the commands Clearance Calculations: Extrathoracic and Clearance Calculations: Thoracic, to view the corresponding plots and statistics for the number of disintegrations or the rate of disintegrations (FIGS. 18 and 19).

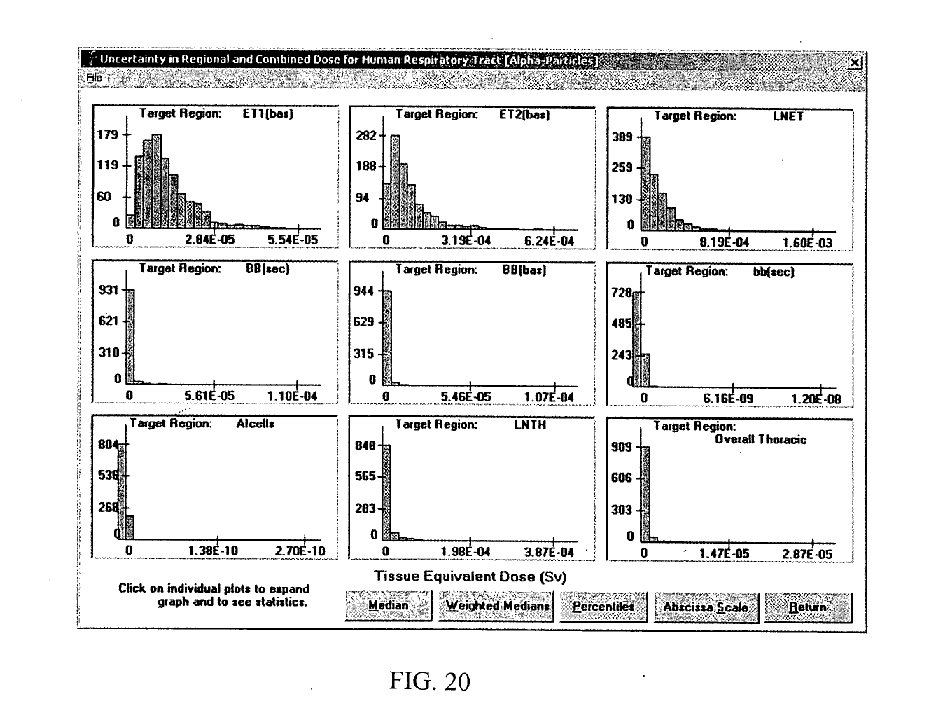

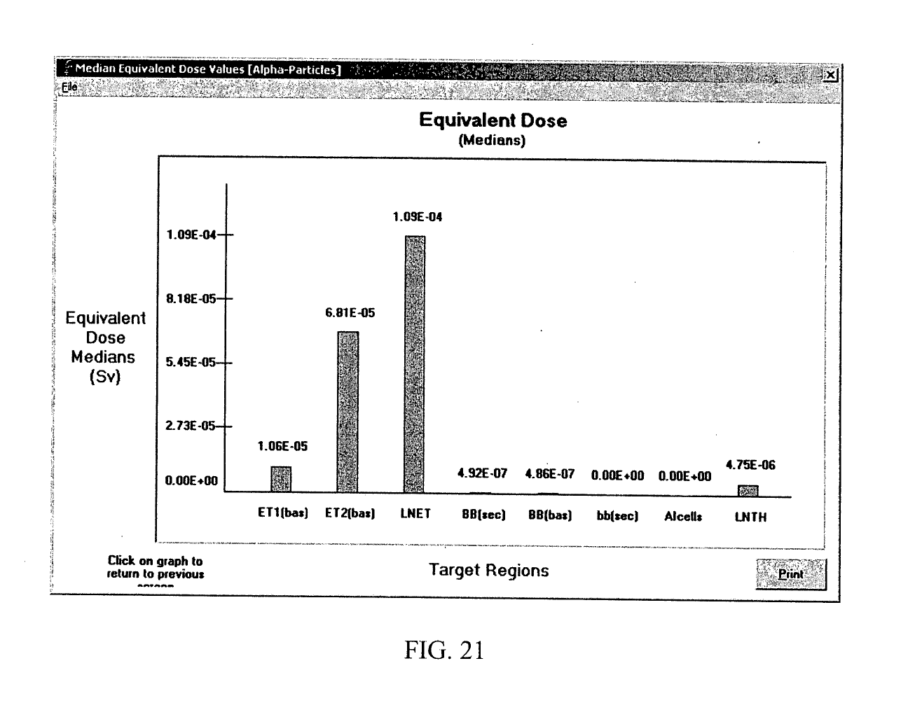

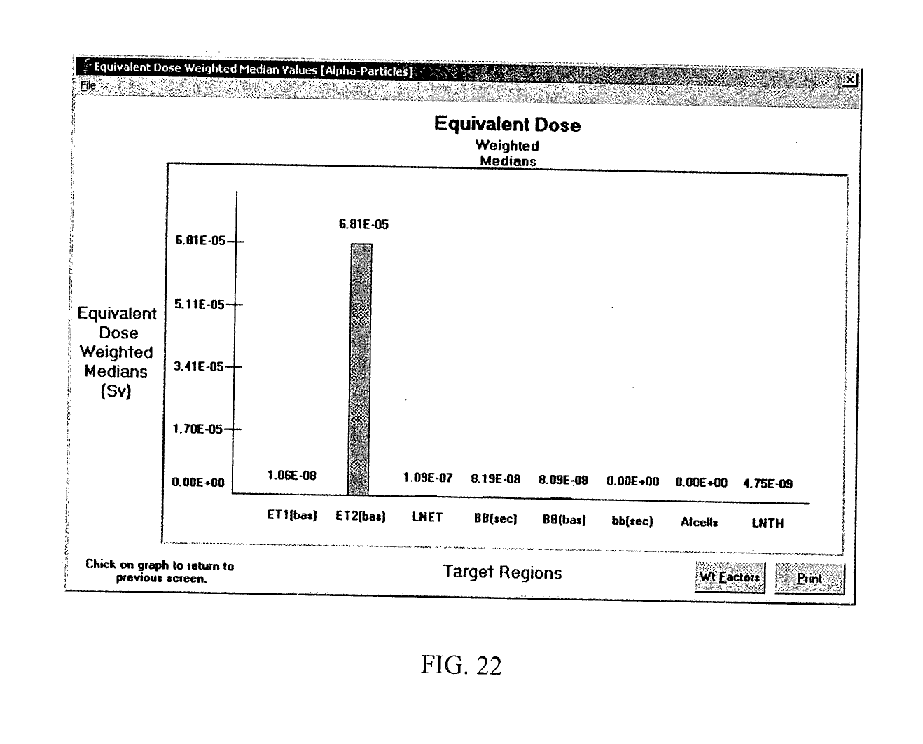

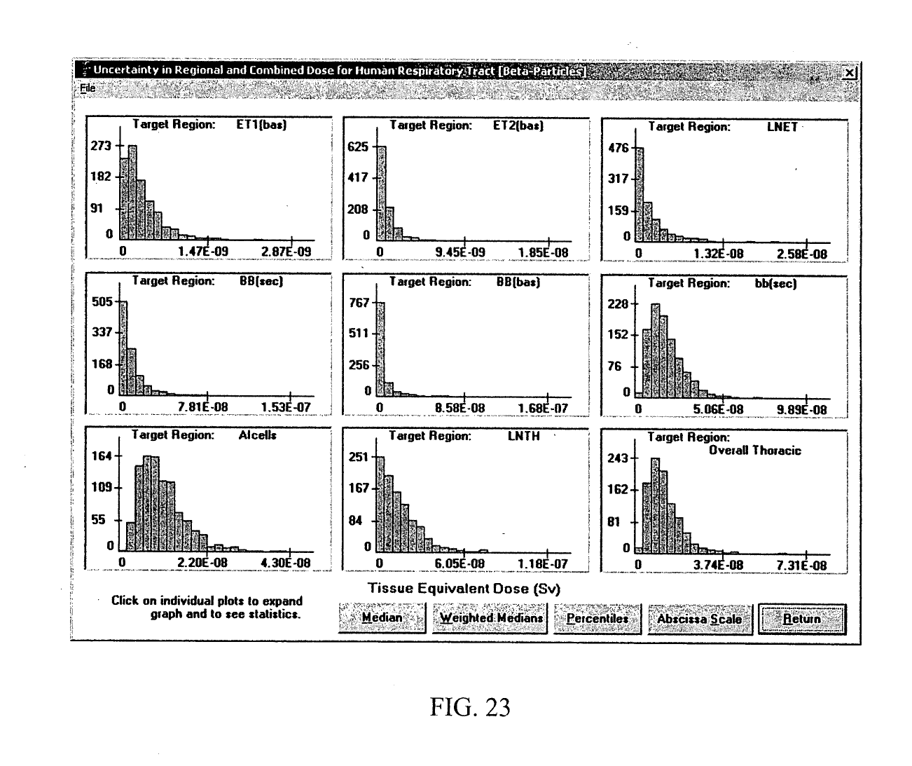

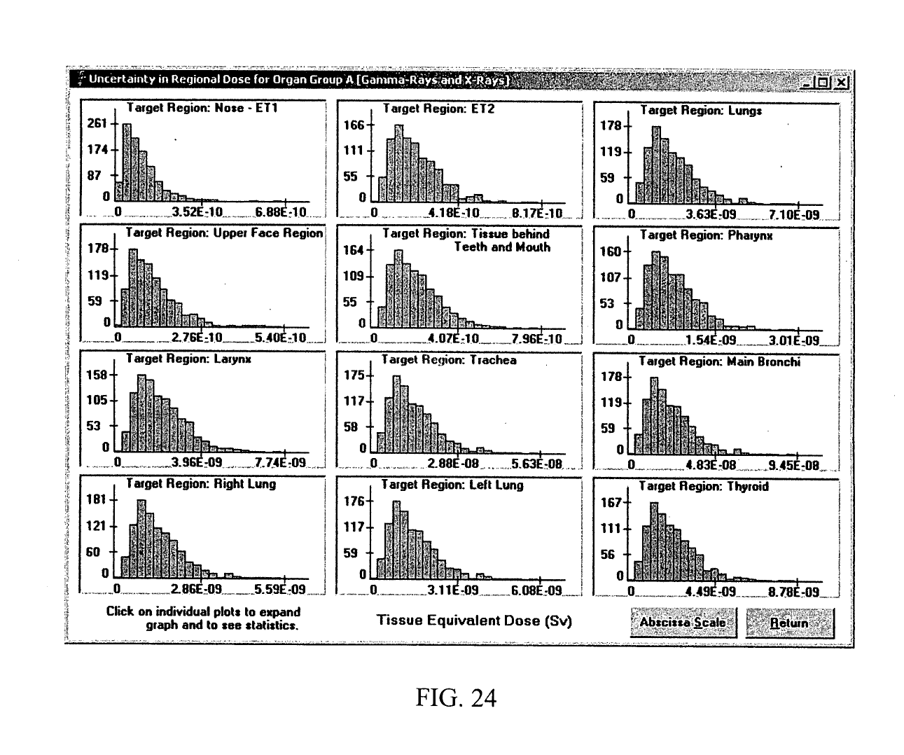

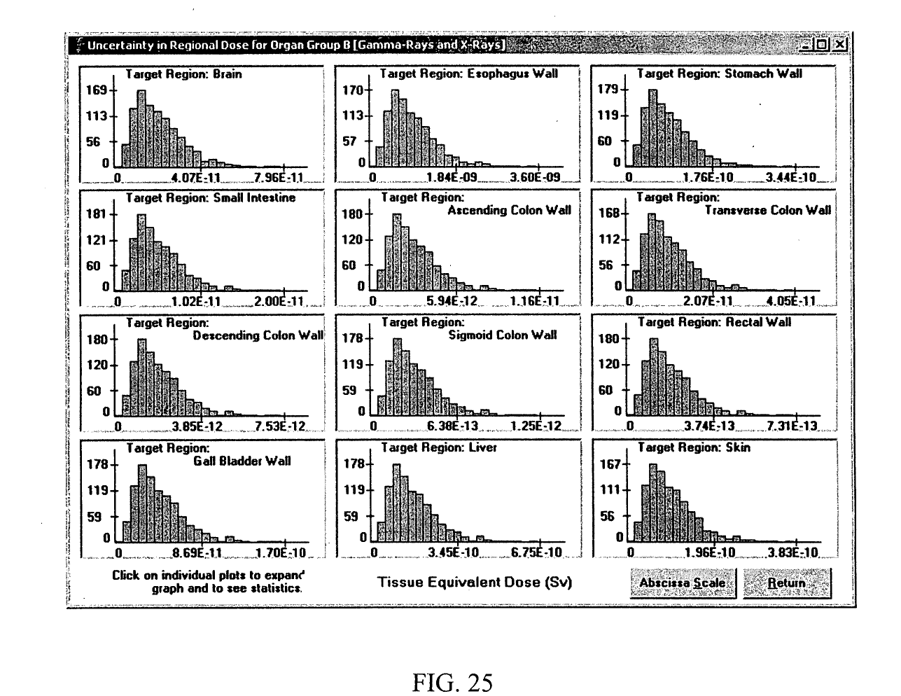

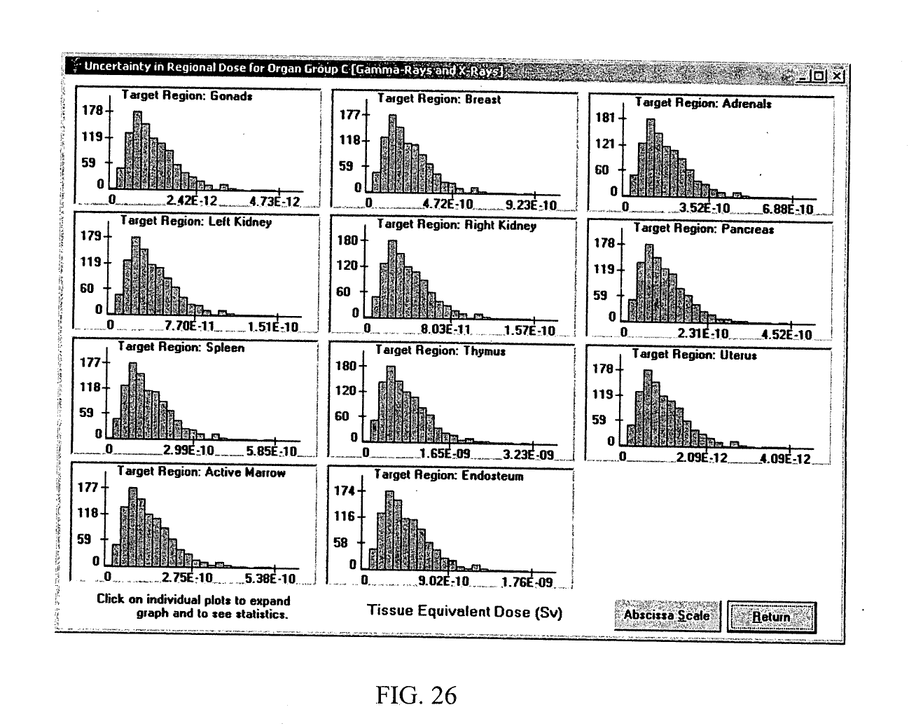

Again referring to FIG. 15, to observe the results from the dosimetry model, the user can select one of the several Dose Calculations commands. The results for the dose model are divided into three main groups: alpha particles (sample data shown in FIGS. 20-22), beta particles (FIG. 23), and gamma-rays/x-rays (FIGS. 24-26). The user is also able to see the median, weighted median, and percentiles by clicking on the corresponding commands in the window shown in FIG. 20.

Referring again to FIG. 15, the dose calculation results for gamma-rays/x-ray are further divided into three main groups (i.e., Groups A, B, and C). Each of these groups includes a number of target organs or tissues, as can be seen in FIGS. 24-26. From the menu shown in FIG. 15, the user is able to determine which tissues or organs are included in each group by locating the mouse pointer over the commands for dose calculations for Organ Groups A, B, or C.

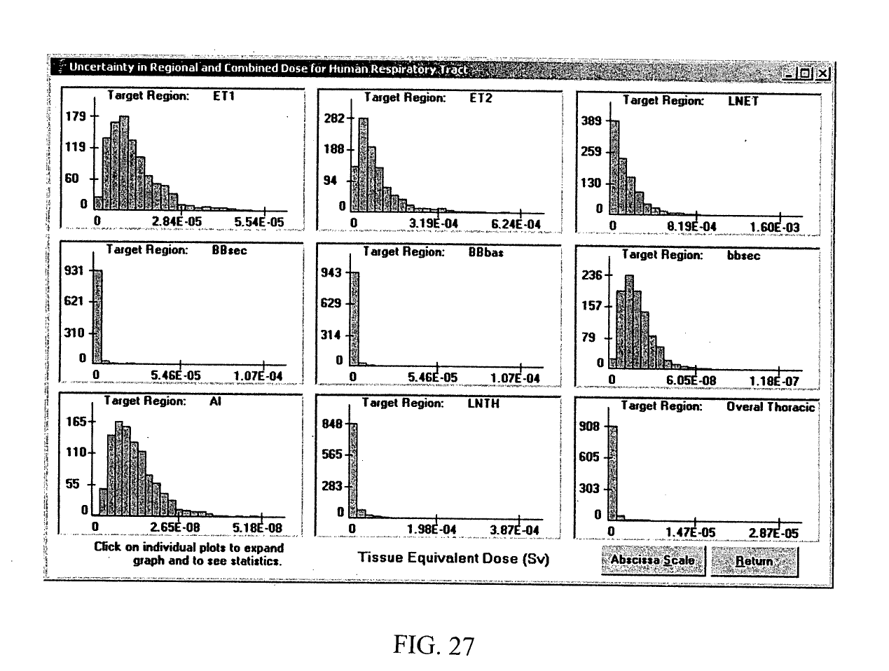

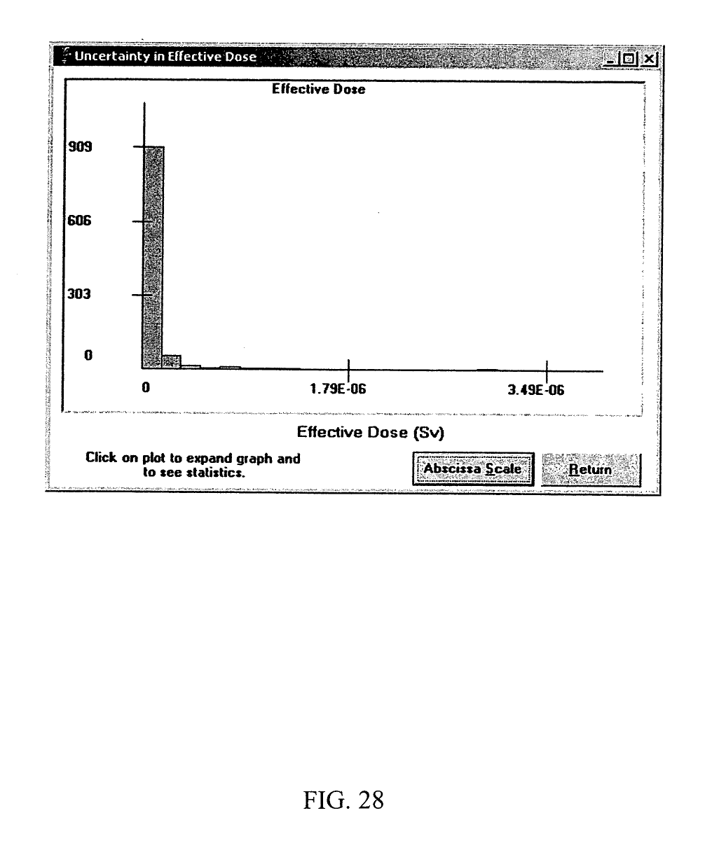

The user is also able to observe the results for Equivalent Doses and Effective Dose by clicking on the corresponding commands shown in the menu in FIG. 15. Examples of the displayed results for Tissue Equivalent Dose (Sv) and Effective Dose (Sv) are shown in FIGS. 27 and 28, respectively.

### EXAMPLES

### Example 1

### Predicting Uncertainties in the Deposition Model of the ICRP-66 Respiratory Tract Model

Predicting the deposition behavior of aerosols in the respiratory tract is necessary to estimate the fractions of radioactivity that are deposited in each anatomical region of the lungs. These fractions are required in the assessment of health risks associated with the inhalation of radioactive aerosols.

Methods: A complete respiratory tract deposition methodology based on the ICRP 66 Respiratory Tract Model was used in an analysis of plutonium, uranium and americium oxide aerosol particles. Lung deposition fractions were estimated as probability distributions to reflect the variability or spread in the deposition values. The methodology was implemented using the LUDUC computer code.

Results. The deposition fractions followed a lognormal distribution shape for all exposure scenarios examined. In general, median distribution fractions generated by LUDUC agreed with the reference deposition fractions of the deterministic computer code LUDEP. However, the results showed that the particle aerodynamic diameter and the physical exertion level (sleeping, resting, light exertion, and high exertion) strongly influenced the deposition uncertainty.

### Example 2

### Predicting Uncertainties in the Clearance Model of the ICRP-66 Respiratory Tract Model

Estimating respiratory tract clearance rates of radioactive aerosols is essential in the estimation of health risks associated with the inhalation of radioactive aerosols and vapors. Accurate methodology of clearance kinetics is required because respiratory tract clearance rates determine not only doses to the respiratory tract tissues, but also doses to other organs following systemic uptake. Aerosols deposited in the respiratory tract are cleared to the gastrointestinal tract via the pharynx, the regional lymph nodes via the lymphatic channels, and blood via absorption. In general, the rate at which deposited aerosols are cleared depends on the time elapsed since the deposition of aerosols, the physicochemical form of the aerosols, and the location of the aerosols in the respiratory tract.

Methods: A detailed respiratory tract clearance methodology based on the IRCP 66 Respiratory Tract Model was used to study ²⁴¹Am, ²³⁵U, ²³⁸U, and ²³⁹Pu oxide aerosols. The methodology utilized LUDUC, a computer code that permits lung clearance rates to be calculated as probability distributions to reveal the spread in clearance rate values.

Results. The clearance rates had a lognormal distribution shape for all examined exposure conditions. The results showed that clearance uncertainty is highly subject to the physicochemical properties of the aerosols.

### Example 3

### Predicting Uncertainties in the Dosimetry Model of the ICRP-66 Respiratory Tract Model

A complete respiratory tract model for predicting lung dosimetry of inhaled radioactive aerosols involves several component models, including models for particle deposition in the airways, biokinetic clearance, radiological decay of deposited materials, and radiological dose to critical target tissues. Each component depends on several parameters, which can vary among members of a population group.

Methods. A methodology was developed, based on conducting parameter uncertainty analyses, to incorporate parameter uncertainties into the predictions of lung doses. Results of previous studies were compiled to recommend distributions representative of parameter uncertainties, and the methodology was implemented using LUDUC, an interactive computer program. Doses resulting from inhalation of uranium and plutonium oxide aerosols with aerodynamic diameters ranging from 0.1 to 50 microns were investigated.

Results. Dose distributions followed a lognormal distribution shape for all exposure scenarios examined. Median doses for uranium and plutonium oxide generally agreed with reference dose values, providing some level of confidence in the approach using Reference Man. Differences in the predicted dose distributions were small when comparing different age and gender groups from 2 to 35 years of age.

### Example 4

### Analysis of Parameter Sensitivity in the ICRP-66 Respiratory Tract Model

A sensitivity analysis of all model parameters within the ICRP-66 Respiratory Tract Model is essential for the estimation of probabilistic dose distribution in lung dosimetry.

Methods. This analysis was performed to identify those model parameters which most influence model predictions, and to determine the contribution made by parameter variabilities to uncertainties in the model predictions. Sensitivity analyses were conducted for adult males, 25-34 years old, exposed to ²³⁹PuO₂ aerosols at a light exertion level, assuming acute deposition using the rank-transformed dose and deposition data generated by the computer code LUDUC. The sensitivities of model predictions on input variables were performed by determining the standardized rank regression coefficients (SRRCs) of selected input variables. Based on absolute values of their associated SSRCs, input variables were ranked in increasing values from one, with the most important, i.e., the most sensitive variable being assigned a rank of one. The data were generated by performing N=1000 trials using Latin Hypercube sampling techniques.

Results. In general, calculated uncertainties generally increase as the particle diameter increases from 0.1 to 50 μm. However, the calculated median dose decreases with increasing particle diameter over this same size range. Generally, uncertainties in lung and tissue equivalent doses can be modeled by lognormal distributions. Sensitivities in dose predictions differed between target tissues and were influenced by particle size, due primarily to dependencies in the deposition model. The SSRCs technique was generally able to explain over 90% of the variablility in the dose and deposition predictions. For the deposition component of the respiratory tract model, a larger portion of the variability in deposition and dose model predictions was attributable to only a few model parameters.

### Example 5

### Revised Dosimetric Model of the Extrathoracic and Thoracic Airways

The extrathoracic airways and lymph nodes have not been previously represented explicitly in mathematical models of the human body which are utilized to predict transport of photons internally between source and target organs within the body. The current ICPR Respiratory Tract Model assumes that the extrathoracic airways are reasonably approximated by using the thyroid as a surrogate source and target region. Consequently, the thyroid replaces the extrathoracic airways and lymph nodes (ET₁, ET₂, and LN_{ET}) as the emission site or deposition site for photons released from inhaled radioactive particulates.

Methods. A new mathematical model was created to explicitly represent the extrathoracic airways, as well as other respiratory structures in the thorax of the adult. The model incorporated the revised dosimetric Medical Internal Radiation Dose (MIRD) model of the adult head and brain and the Oak Ridge National Laboratories model of the adult male. Several modifications were made, to include a number of organs and tissue regions absent from previous models. The resulting mathematical model included an external nose, nasal cavity, nasal sinuses (frontal, ethmoid, sphenoid, and maxillary), larynx, pharynx, trachea, main bronchi, and esophagus. The model was implemented into the MCNP radiation transport code to determine specific absorbed fractions. The specific absorbed fractions and the new mathematical phantom were incorporated into the LUDUC computer program. (See FIG. 15.)

Results. The ET₁, ET₂, and LN_{ET} regions represented a more realistic mathematical model of the human respiratory tract tissues, enabling more accurate estimation of uncertainties in dose within the ICRP-66 respiratory tract model for photon emitters.

### Example 6

### Beta-Particle Uncertainty Within the ICRP-66 Respiratory Tract Model Impact of Uncertainties in Electron Absorbed Fractions on Lung Dose Estimates

This analysis was performed to investigate the short-range dosimetry model of the ICRP-66 Respiratory Tract Model whereby probability density functions are assigned for target depths, thicknesses, and masses.

Methods. The LUDUC probabilistic computer code was modified to include capability to analyze beta-particle emitters. To create the data files, Monte Carlo transport simulations were performed for beta particles. LUDUC was then used to assess regional and total lung doses from inhaled aerosols of ⁹⁰Sr and ⁹⁰Y compounds.

Results. Dose uncertainty was found to depend mainly on particle size. For strontium and yttrium compounds of the inhalation class Y, the results showed that the spread in lung dose increased by factors of about 10 over the particle size range from 0.001 to 10 μm. The ratio of the 95% to 5% fractile was relatively constant for particle diameters of 0.01 to 0.2 μm, i.e., 10 and 3 for ⁹⁰Sr and ⁹⁰Y, respectively. This difference increased to about a factor of 100 as the particle diameter approached 10 μm. This was mainly due to the fact that thoracic doses become low at larger particle sizes because most of the deposition occurs in the extrathoracic region.

### Example 7

### Analysis of Uncertainties in the Electron Absorbed Fractions within the ICRP-66 Respiratory Tract Model

The uncertainties of beta-particle transport and energy deposition were analyzed. For short-ranged beta particles, critical parameters of dose assessment are based in part on estimates of target tissue depths, thickness, and masses, predominantly within thoracic regions of the respiratory tract.

Methods. To model uncertainty in doses for beta particles, probability density functions were assigned for target tissue depths, thickness and masses, using LUDUC, as described in Example 6. Unlike the methodology utilized by the ICRP-66 model for alpha particles, in which range-energy relationships are used to account for alpha particle deposition in lung tissues, full Monte Carlo radiation transport simulations were made for beta particles due to their non-linear pathlengths within these tissues. EGS4 code was used in the ICRP-66 model to simulate beta-particle energy deposition and absorbed fractions in lung airways.

The complexity of the work was significantly simplified due to the fixed geometry for both target cell depths and thicknesses, and source tissue depths and thicknesses. Both of these combinations of distances were varied stochastically. Furthermore, in situations in which an intermediate tissue was located between the source and target tissues, the thickness of this intermediate region could be varied. As a result, a new scheme was developed and implemented into the MCNP 4C radiation transport code.

Results. In the new scheme, the airways of the BB (bronchial) and bb (bronchiolar) regions are subdivided into thin (i.e., 1 μm thick) cylindrical shells. In general, each shell is considered as a potential source. This methodology enables assessment of regional and total lung dose from inhaled aerosols of beta-particles, such as ⁹⁰Sr and ⁹⁰Y compounds.

### Other Embodiments

While the above specification contains many specifics, these should not be construed as limitations on the scope of the invention, but rather as examples of preferred embodiments thereof. Many other variations are possible. Accordingly, the scope of the invention should be determined not by the embodiments illustrated, but by the appended claims and their legal equivalents.

What is claimed is:

1. A method for solving a respiratory tract model comprising the steps of:
selecting a group of input parameters associated with a respiratory tract model;
computing a probability density function for each of said input parameters in said group; and,
solving said respiratory tract model associated with said input parameters using said computed probability density functions.

2. The method of claim 1, wherein said selecting step comprises the step of selecting a group of input parameters associated with a respiratory tract model, said respiratory tract model comprising the ICRP-66 Respiratory Tract Model.

3. The method of claim 2, wherein said selecting step comprises the step of selecting a group of input parameters associated with a respiratory tract model, said parameters comprising at least one parameter selected from the group of parameters associated with the ICRP-66 Respiratory Tract Model.

4. The method of claim 1, wherein said solving step comprises the step of generating at least one of a mean estimate, a median estimate and an uncertainty of a radiation dose based upon said computed probability density functions.

5. The method of claim 1, further comprising the step of modifying said respiratory tract model to explicitly represent anatomical structures of a human being.

6. The method of claim 5, wherein said modifying step comprises the step of modifying said respiratory tract model to explicitly represent anatomical structures of a human being, said structures comprising at least one of an external nose, nasal cavity, nasal sinus, larynx, pharynx, trachea, main bronchus and esophagus.

7. A machine readable storage having stored thereon a computer program for solving a respiratory tract model, the computer program comprising a routine set of instructions for causing the machine to perform the steps of:
selecting a group of input parameters associated with a respiratory tract model;
computing a probability density function for each of said input parameters in said group; and,
solving said respiratory tract model associated with said input parameters using said computed probability density functions.

8. The machine readable storage of claim 7, wherein said selecting step comprises the steps of selecting a group input parameters associated with a respiratory tract model, said respiratory tract model comprising the ICRP-66 Respiratory Tract Model.

9. The machine readable storage of claim 8, wherein said selecting step comprises the step of selecting a group input parameters associated with a respiratory tract model, said parameters comprising at least one parameter selected from the group of parameters associated with the ICRP-66 Respiratory Tract Model.

10. The machine readable storage of claim 7, wherein said solving step comprises the step of generating at least one of a mean estimate, a median estimate and an uncertainty of a radiation dose based upon said computed probability density functions.

11. The machine readable storage of claim 7, further comprising the step of modifying said respiratory tract model to explicitly represent anatomical structures of a human being.

12. The machine readable storage of claim 11, wherein said modifying step comprises the step of modifying said respiratory tract model to explicitly represent anatomical structures of a human being, said structures comprising at least one of an external nose, nasal cavity, nasal sinus, larynx, pharynx, trachea, main bronchus and esophagus.

13. A system for solving a respiratory tract model comprising:
a scenario specification module for defining an exposure scenario;
a Latin Hypercube sampling module;
a particle deposition module for repeatedly computing a particle deposition component of a respiratory tract model, and a clearance component module for repeatedly computing a clearance component of said respiratory tract model;
a dose matrix computing component for computing a dose matrix for alpha particles;
an MCNP module both for determining absorbed beta particle fractions and for determining specific absorbed photon fractions;
a dose computation module for computing equivalent doses and combined doses in target tissues; and,
an interface through which statistical representations are provided from said deposition, said clearance and said dose computation modules.

14. The system of claim 13, wherein said statistical representations comprise at least one of a minimum, maximum, median, mean, standard deviation, coefficient of variance, geometric mean, geometric standard deviation and percentile.

15. The system of claim 13, wherein said respiratory tract model is an ICRP-66 Respiratory Tract Model.
